(19) United States
(12) Patent Application Publication
(10) Pub. No.: US 2002/0021948 A1
(43) Pub. Date: Feb. 21, 2002

(54) Metallic insert with ribs

(76) Inventors: Michael Stumpf, Bielefeld (DE); August Borchard, Lemgo (DE)

Correspondence Address: SEYFARTH SHAW, Suite 4200, 55 East Monroe Street, Chicago, IL, 60603-5803, US

(21) Appl. No.: 09/803,302

(22) Filed: Mar. 9, 2001

(30) Foreign Application Priority Data
Mar. 17, 2000 (DE) 100 13 091.7

(51) Int. Cl. F16B 37/04

(52) U.S. Cl. 411/180

(57) ABSTRACT

A metallic insert to be embedded into an opening of a structural member of a material of relatively low strength. The metallic insert has a main body comprising a plurality of coaxially superimposed truncated cones and a recessed portion adjacent to the truncated cones. The recessed portion is provided with at least two radially extending ribs to increase the insert's resistance to relative rotational movements. As a result thereof the metallic insert which requires only relatively small forces to be embedded into the structural member is of high resistance both to extraction and rotational movements of said metallic insert with respect to the structural member.

### BACKGROUND OF THE INVENTION

The invention relates to a metallic insert to be embedded into an opening of a structural member of a material of relatively low strength, in particular of thermoplastic material.

A metallic insert of this type, in particular a threaded insert, generally is inserted into the respective opening of the structural member while the plastic material surrounding the opening of the structural member is being molten by heat or ultrasonic energy, and thereafter the insert is pressed into the opening by a respective force (heat embedding, ultrasonic welding). Furthermore, it has become known to embed the metallic insert into the material of the structural member by cold deformation or injection molding of the material. In order to secure the insert against extraction and rotational movements, the insert generally has its peripheral surface provided with surface irregularities such as undercuts, grooves, flutes, toothings, etc. For example, U.S. Pat. No. 4,046,181 discloses an insert having a main body comprising a plurality of coaxially superimposed truncated cones which are provided with toothings at their peripheries. These measures allow to decrease the forces required to press the insert into the structural member and to increase the resistance to relative rotational movements. At the same time, however, this will decrease the insert's resistance to extraction. The requirements for small embedding forces and high resistance to extraction and rotational movements are not really compatible to each other.

### SUMMARY OF THE INVENTION

It is an object of the invention to provide a metallic insert to be embedded into an opening of a structural member of relatively low strength, which is of maximal resistance to extraction and relative rotational movements and nevertheless requires only minimal embedding forces.

The metallic insert of the present invention has a main body comprising a plurality of axially superimposed truncated cones and a recessed portion adjacent a terminal truncated cone. The recessed portion is provided with at least two radial ribs to increase the insert's resistance to relative rotational movements.

Due to the presence of said radial ribs it is not necessary to provide toothings at the peripheries of the truncated cones. The required resistance to relative rotational movements is obtained by the radial ribs which do not increase the forces required for embedding the insert into the opening of the structural member. Furthermore, the insert of the invention has a relatively high resistance to extraction because the truncated cones of the main body do not require any toothings at their peripheries.

Rather, it is sufficient to provide the truncated cones with e.g. two rows of axially aligned grooves which enable material flow towards said recessed portion when the insert is pressed into the opening of the associated structural member. Preferably, an annular flange is provided adjacent said recessed portion, with said annular flange being of a diameter equal to or greater than the maximal outer diameter of the radial ribs. This ensures that the material of the structural member which has been molten or otherwise deformed during the embedding operation will be collected and rigidified in the recessed portion.

The insert of the invention is of relatively high resistance both to extraction and relative rotational movements and nevertheless requires only relatively small embedding forces. Furthermore, it is of relatively simple geometrical shape so that it can be made at minimal cost.

### BRIEF DESCRIPTION OF THE DRAWINGS

For the purpose of facilitating the understanding of the invention, there is illustrated in the accompanying drawings a preferred embodiment thereof, from an inspection of which, when considered in connection with the following description, the invention, its construction and operation, and many of its advantages should be readily understood and appreciated.

FIG. 1 is a perspective view of an insert;

FIG. 2 is a side elevation of the insert of FIG. 1;

FIG. 3 is a side elevation of the insert rotated about 90° with respect to FIG. 2;

FIG. 4 is a bottom view of the insert;

FIG. 5 shows a detail indicated by Y in FIG. 2;

FIG. 6 shows a detail indicated by X in FIG. 2.

### DESCRIPTION OF THE PREFERRED EMBODIMENT

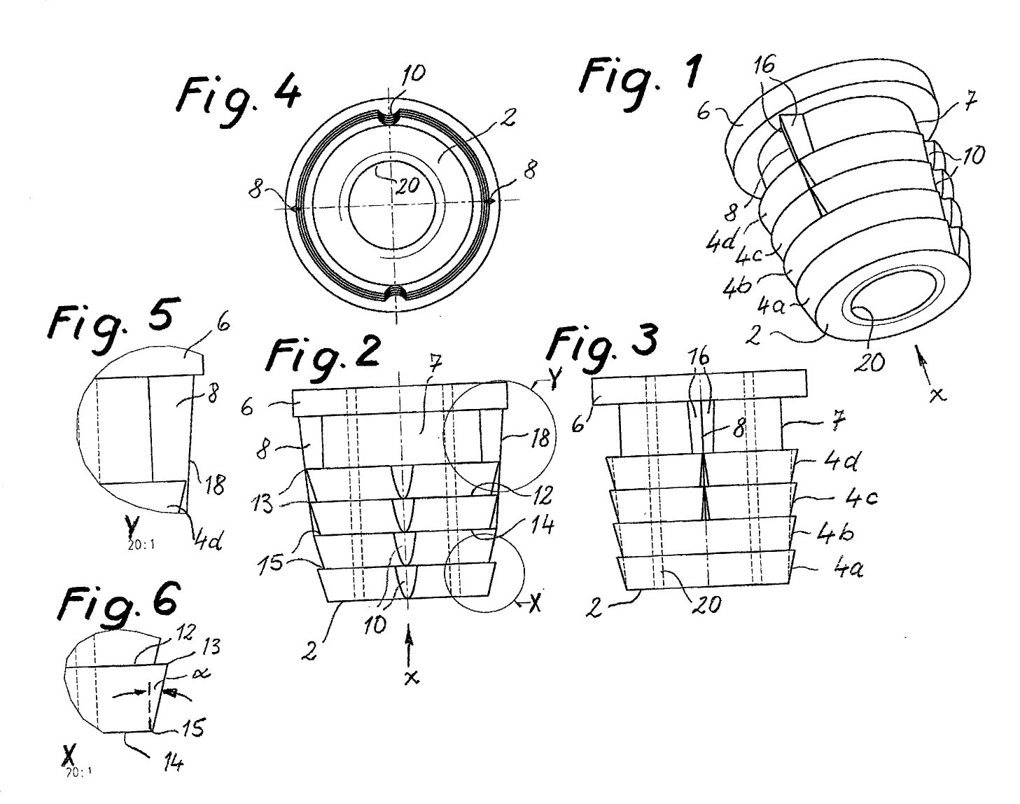

Referring to FIGS. 1 to 4, the metallic insert shown therein is to be embedded into a bore or other opening of a structural member (not shown) which is made of a material of relatively small strength such as plastic material. Preferably the insert is embedded into a structural member of thermoplastic material by a heat or ultrasonic or inductive embedding operation. As an alternative the insert can be embedded into the structural member by injection molding or pressing in a deforming operation.

The insert comprises a main body 2 which consists of a plurality of coaxially superimposed truncated cones 4a, 4b, 4c and 4d. The main body 2 is of generally conical shape in order to facilitate the embedding operation. A further advantage thereof is that the energy which is required to plastify the plastic material during the heat embedding operation will be transferred more quickly from the metallic insert to the structural member. It should be noted, however, that the main body 2 could also be of a generally cylindrical shape depending on the requirements of a special application.

The truncated cones 4a to 4d preferably are of the same height which is selected depending on the material and dimensions of the structural member and will be given by a certain percentage of the total length of the insert. In order to provide for the general conical shape of the main body the diameters of the truncated cones 4a to 4d are reduced stepwise in the so-called extraction direction which is indicated by arrow x in FIGS. 1 and 2. More precisely, the circumferential lines 13 and 15 of the large and small base surfaces 12 and 14 of the truncated cones 4a to 4d each lie in a virtual conical surface having a cone angle of preferably about 4°. It should be noted, however, that the cone angle could be greater and smaller depending on the specific application.

The cone angle of the truncated cones 4a to 4d preferably is between 60° and 90°; i.e. the half cone angle α (see FIG. 6) is between 30 and 45°. The greater the cone angle, the greater are the undercuts between the various truncated cones thereby to increase both the resistance to embedding and the resistance to extraction. Therefore, an acceptable compromise can be found depending on the specific application and in particular on the strength of the material of the structural member. Basically, the smaller the strength of the material of the structural member will be, the larger should be the angle α.

Adjacent to the large base surface 12 of the terminal truncated cone 4d there is a recessed portion 7 comprising an annular groove which is limited on its opposite side by an annular flange 6. In the embodiment as shown both the peripheral surface of the recessed portion 7 and the peripheral surface of the annular flange 6 are of cylindrical shape. It should be noted, however, that other geometrical shapes could be provided.

The recessed portion 7 is provided with a pair of radial ribs 16 offset with respect to each other by 180°. It would be possible to provide more than two radial ribs, for example three or four ribs.

As shown in particular in FIGS. 1 and 3, the ribs 8 are confined by lateral surfaces 16 which are inclined with respect to an axial plane and which include an angle of about 30 to 60°. The radially outer sides 18 of the ribs 8 are slightly inclined with respect to the axis of the insert, in conformity with the general conical shape of the main body 2. Accordingly, the radially outer sides 18 of the two ribs 8 also include an angle of about 4°.

As indicated in FIGS. 1 to 3, the ribs 8 extend from the recessed portion 7 axially into the area of the truncated cones 4d and 4c and could be prolonged so as to extend for example also into the area of the truncated cone 4b. The arrangement is such that the radially outer sides 18 of the ribs 8 are disposed in the virtual conical enclosing surface which includes also the peripheral lines 13 of the large base surfaces 12 of the truncated cones 8. The maximal diameter of the radially outer sides 18 of the ribs 8 (adjacent the annular flange 6) is equal to or smaller than the outer diameter of the annular flange 6.

The purpose of the recessed portion 7 is to receive and take up material of the structural member which is deformed and displaced during the embedding operation. The recessed portion 7, accordingly, serves as a “dam” for material flow and provides for a substantial undercut thereby to increase the extraction resistance (resistance to axial loading). The annular flange 6 prevents exit of material from the recessed portion 7. Depending on the specific application the annular flange could be dispensed with.

The radial ribs 8 provide for high resistance to relative rotational movements. Due to their specific geometrical shape they do not affect the finding (threading) and embedding operation.

The truncated cones 4a to 4d are provided with axially extending peripheral grooves. As shown in FIGS. 1 to 4 the grooves 10 are arranged in a pair of rows of axially aligned grooves which are circumferentially offset with respect to the ribs 8 for 90°. Instead of two rows there could be provided more than two rows, for example three or four rows.

The grooves 10 are provided to allow for material flow during the embedding operation in the extraction direction x to the next adjacent truncated cone and finally into the recessed portion 7. If the opening of the structural member is formed as a blind bore, they furthermore allow for “venting” of the blind bore so that there will be no “air cushion” below the insert. The material remaining within grooves 10, furthermore, assists in increasing the resistance to relative rotational movements.

The insert shown in the drawing is a threaded insert provided with a threaded bore 20. It should be noted, however, that a smooth bore could be provided instead of a threaded bore 20 depending on the specific application. Furthermore, the insert could perform the function of a bolt or any other suitable function.

As already mentioned, the metallic insert is preferably embedded into the opening of a thermoplastic structural member by a heat embedding operation. The insert and the opening of the structural member are dimensioned such that the insert can be inserted into the opening of the structural member for about half of its length without any external force. The general conical shape of the main body 2 facilitates initial positioning of the insert within the opening of the structural member. The insert will be pressed into the molten plastic material of the wall of the opening of the structural member by a predetermined embedding force in a direction opposite to the extraction direction x. The molten material will flow through the axial grooves 10 into the “undercut areas” of the truncated cones 4a to 4d where the molten material spreads and forms some kind of a “dam”. A substantial amount of the molten material will eventually flow to the last and most important “dam” which is formed by the recessed portion 7. The molten material will fill the recessed portion 7 while the annular flange 6 prevents the material from flowing out of the recessed portion 7. The material which has flown into the undercut areas of the truncated cones 4a to 4d and the recessed portion 7 will eventually rigidify. The undercut areas of the truncated cones 4a to 4d and in particular the recessed portion 7 will provide for high resistance to extraction in the direction x while the axial grooves 10 and in particular the radial ribs 8 provide for high resistance to relative rotational movements.

What we claim is:

1. A metallic insert to be embedded into an opening of a structural member of material of relatively low strength, said metallic insert comprising a main body comprising a plurality of superimposed truncated cones and a recessed portion adjacent a therminal truncated cone of said plurality of truncated cones and being of a diameter which is smaller than a maximal diameter of said terminal truncated cone, said recessed portion being provided with at least two radially extending ribs to increase said insert's resistance to relative rotational movements.

2. The metallic insert of claim 1 wherein said at least two radially extending ribs are offset with respect to each other for 180°.

3. The metallic insert of claim 1 wherein said at least two radially extending ribs extend axially into at least some of said truncated cones.

4. The metallic insert of claim 1 wherein each of said ribs has at least two lateral surfaces inclined with respect to an axial plane and enclosing an angle of substantially 30° to 60°.

5. The metallic insert of claim 1 wherein said truncated cones each have large and small base surfaces defined by circular peripheral lines, the peripheral circular lines of the large base surfaces of said truncated cones being positioned in a virtual conical enclosing surface which is divergent in an extraction direction of said metallic insert.

6. The metallic insert of claim 5 wherein said ribs have radially outer surfaces which are slightly inclined such that they are positioned in said virtual conical enclosing surface.

7. The metallic insert of claim 5 wherein said virtual conical enclosing surface has a cone angle of about 4°.

8. The metallic insert of claim 1 wherein an annular flange adjacent and integral with said recessed portion is of a diameter which is similar to or greater than a maximal outer diameter of said ribs.

9. The metallic insert of claim 1 wherein said truncated cones, at their peripheries, are provided with axially extending grooves.

10. The metallic insert of claim 9 comprising one axial row or a plurality of axial rows of said grooves.

11. The metallic insert of claim 10 wherein said row or rows of said grooves is or are circumferentially offset with respect to said ribs by about 90°.

12. The metallic insert of claim 9 wherein said grooves are of radiused cross-section.

13. The metallic insert of claim 1 wherein said truncated cones are of the same axial height.

14. The metallic insert of claim 1 wherein said truncated cones each include a cone angle of about 60 to 90°.

15. The metallic insert of claim 1 wherein said main body is provided with a central tapped bore or other bore.
